(19) United States
(12) Patent Application Publication
(10) Pub. No.: US 2025/0091273 A1
(43) Pub. Date: Mar. 20, 2025

(54) SYSTEM AND METHOD OF MAKING A MESH CUSHION

(71) Applicant: Lear Corporation, Southfield, MI (US)

(72) Inventors: Sam BLAIR, Southfield, MI (US); Joshua HALLOCK, Southfield, MI (US); David ABDELLA, Southfield, MI (US); Pat CARLSEN, Southfield, MI (US); Michelle A. PERENY, Southfield, MI (US)

(21) Appl. No.: 18/961,808

(22) Filed: Nov. 27, 2024

Related U.S. Application Data
(63) Continuation of application No. 18/082,978, filed on Dec. 16, 2022.
Application No. 18/082,978 is a continuation-in-part of application No. 17/555,875, filed on Dec. 20, 2021.

(51) Int. Cl. B29C 48/00; B25J 9/00; B29C 48/05; B29C 48/345; B29L 31/00

(52) U.S. Cl. CPC B29C 48/0011; B25J 9/0096; B29C 48/05; B29C 48/345; B29L 2031/751

(57) ABSTRACT

A method of making a mesh cushion. The method includes extruding a material through a plurality of filament forming openings in at least one die plate to form a plurality of filaments. The filaments may be at least partially submerged into a fluid to cool and harden the filaments into the mesh cushion.

### CROSS-REFERENCE TO RELATED APPLICATIONS

This application is a continuation of U.S. application Ser. No. 18/082,978 filed Dec. 16, 2022, now U.S. patent Ser. No. ______ which is a continuation-in-part of U.S. application Ser. No. 17/555,875 filed Dec. 20, 2021, now U.S. patent Ser. No. ______ the disclosures of which are hereby incorporated in their entirety by reference herein.

### TECHNICAL FIELD

This relates to a system and method for making a mesh cushion, such as a mesh cushion for a seat.

### BRIEF DESCRIPTION OF THE DRAWINGS

FIG. 1 is a schematic illustration of an example of a system for making a mesh cushion.

FIG. 2 is a plan view of a portion of FIG. 1 taken below a die plate and above rollers that may be provided with the system.

FIG. 3 is a schematic illustration of a second example of a system for making a mesh cushion.

FIG. 4 is a schematic illustration of a third example of a system for making a mesh cushion.

FIGS. 5A and 5B illustrate examples of differently sized filaments.

FIGS. 6A and 6B are examples of die plates that may be provided with any system associated with FIGS. 1 through 4.

FIG. 7 is a side view illustrating stacked die plates.

FIGS. 8A and 8B are plan views of the stacked die plates in first and second positions, respectively.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, such as terms “horizontal”, “vertical”, etc., it is referred to the orientation of the drawings. Unless otherwise specified, expressions approximately, substantially, and in the order of mean to within 10%, preferably to within 5%.

The terminology controller may be provided as one or more controllers or control modules for the various components and systems. The controller and control system may include any number of controllers, and may be integrated into a single controller, or have various modules. Some or all of the controllers may be connected by a controller area network (CAN) or other system. It is recognized that any controller, circuit, or other electrical device disclosed herein may include any number of processors, microprocessors, integrated circuits, storage devices, memory devices (e.g., FLASH, random access memory (RAM), read only memory (ROM), electrically programmable read only memory (EPROM), electrically erasable programmable read only memory (EEPROM), or other suitable variants thereof that include computer readable program instructions) and software which communicate with, are configured to communicate with, execute instructions or programs, or co-act with one another to perform algorithms represented by the functions and/or operations disclosed herein. In addition, any one or more of the electrical devices as disclosed herein may be configured to execute a computer-program that is embodied in a non-transitory computer readable medium that is programmed to perform any number of the functions as disclosed herein.

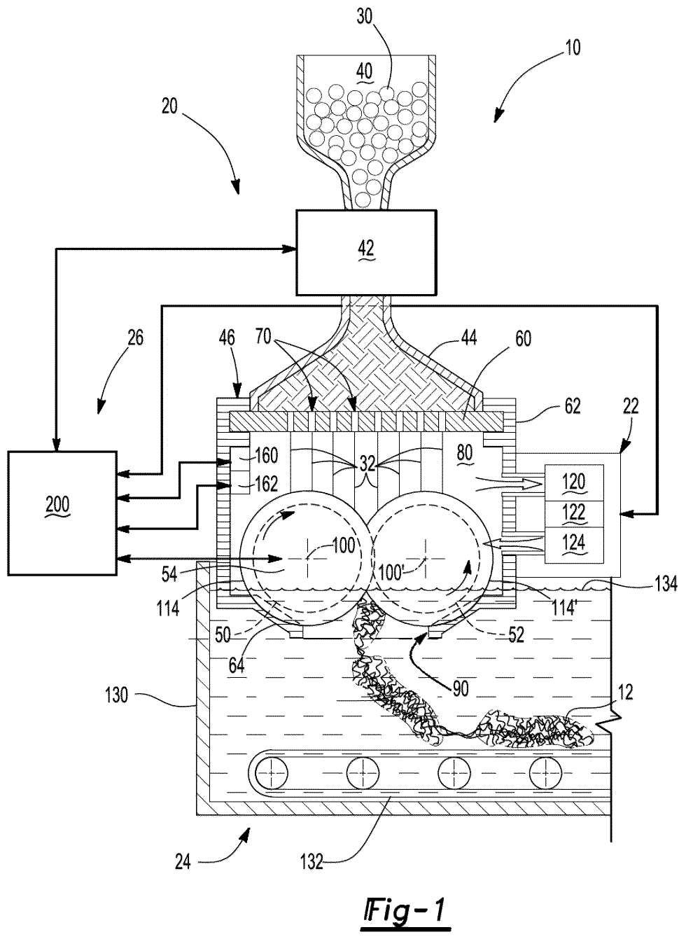

Referring to FIG. 1, an example of a system 10 for making a mesh cushion 12 is shown. The system may include an extruder subsystem 20, an environmental control subsystem 22, a material handling subsystem 24, and a control subsystem 26.

The extruder subsystem 20 may be configured to extrude a material 30 into filaments 32. In at least one configuration, the extruder subsystem 20 may include a container 40, a feeder 42, a manifold 44, and an extruder 46. The extruder subsystem 20 may also include a first roller 50, a second roller 52, and a roller drive unit 54.

The container 40 may contain and store pieces of the material 30 that is to be extruded. For instance, the container 40 may be configured as a hopper that may hold beads, granules, flakes, pellets, or powder made of the material 30. The material 30 may be a polymeric material, such as polyester or polyethylene. The container 40 may be directly mounted to or remotely positioned from the feeder 42.

The feeder 42 may receive the material 30 from the container 40. The feeder 42 may gradually melt and transport the material to the manifold 44. The feeder 42 may have any suitable configuration. For instance, the feeder 42 may include a barrel that may receive a rotatable screw. Rotation of the screw may force the material 30 to move through the barrel and may help heat the material 30 due to the friction generated as the screw rotates. Heating elements, such as thermocouples, may be disposed proximate the barrel and may provide thermal energy that may heat the barrel and the material 30. Optionally, the heating elements may be arranged to provide a heating profile having multiple zones in which the temperature of the material 30 is gradually increased as the material progresses through the barrel. Cooling equipment may also be provided to help keep the temperature below a predetermined value if too much heat is generated. The material 30 may exit the feeder 42 in a molten plastic state.

The manifold 44 may receive the molten material 30 from the feeder 42 under pressure. The manifold 44 may direct the material 30 from the feeder 42 to the extruder 46.

The extruder 46 may extrude the material 30 into filaments 32. The extruder 46 may have any suitable configuration. For instance, the extruder 46 may include one or more die plates 60, a housing 62, and a funnel 64.

One or more die plates 60 may be provided that may include a plurality of filament forming openings 70. The filament forming openings 70 may be small through holes that may be spaced apart from each other and may be sized to create back pressure in the manifold 44 and the barrel. Material 30 provided by the manifold 44 may pass through a filament forming opening 70 under pressure (i.e., be extruded from the die plate 60), thereby forming a filament 32. A filament may be formed by each filament forming opening 70 through which the material 30 passes under pressure.

The housing 62 may receive and support the die plate 60. In addition, the housing 62 may extend between the die plate 60 and the funnel 64. The housing 62 may cooperate with the die plate 60 and the funnel 64 to completely define or partially define a chamber 80. The chamber 80 may be disposed below the die plate 60 and above the funnel 64. As such, filaments 32 formed by or extruded through the die plate 60 may be provided to the chamber 80. The chamber 80 may be an enclosed area that is at least partially separated or isolated from the surrounding environment. In FIGS. 1, 3, and 4, a side of the housing 62 closest to the viewer from the perspective shown has been omitted to better show features inside the housing 62. The environmental control subsystem 22 may help control the environment in the chamber 80 as will be discussed in more detail below.

The funnel 64, if provided, may be disposed proximate the bottom of the housing 62. The funnel 64 may define a funnel opening 90 through which material 30 or a mesh cushion 12 made from the material 30 may pass. The funnel opening 90 may have a smaller width or extend along a shorter distance than the filament forming openings 70 extend along the die plate 60. As such, the funnel opening 90 may help consolidate or condense the filaments 32 in one or more configurations. In at least one configuration, the funnel 64 may extend into a fluid that is provided with the material handling subsystem 24, which may help isolate the chamber 80 from ambient air and the surrounding environment. It is also contemplated that the funnel 64 may be omitted in one or more configurations. It is also contemplated that the housing 62 may extend into a fluid in the material handling subsystem 24 if the funnel 64 is omitted. In the configuration shown in FIG. 1, the funnel 64 receives material 30 that has passed between and has been formed by the first roller 50 and the second roller 52.

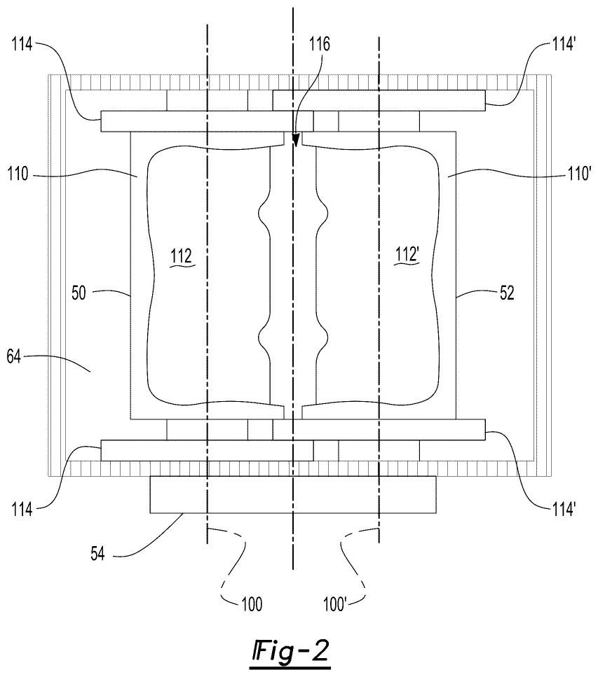

The first roller 50 may be positioned between the die plate 60 and the funnel 64. For instance, the first roller 50 may be positioned below and may be spaced apart from the die plate 60. At least a portion of the first roller 50 may be disposed above the funnel 64 and may be spaced apart from the funnel 64. As such, the first roller 50 may be at least partially received in the chamber 80. The first roller 50 be rotatable about a first axis 100. In at least one configuration and as is best shown in FIG. 2, the first roller 50 may have a first center portion 110, at least one recess 112, one or more end plates 114, or combinations thereof.

The first center portion 110 may extend around or encircle the first axis 100. In at least one configuration, the first center portion 110 may be disposed at a constant or substantially constant radial distance from the first axis 100. The first center portion 110 may be positioned above the funnel 64.

At least one recess 112 may extend from the first center portion 110 toward the first axis 100. In the configuration shown, a single recess 112 is illustrated; however, it is contemplated that multiple recesses may be provided. Moreover, multiple recesses may be spaced apart from each other.

One or more end plates 114 may be provided with the first roller 50. In the configuration shown, two end plates 114 are shown that are disposed proximate opposite ends of the first center portion 110. An end plate 114 may be rotatable about the first axis 100 with the first center portion 110. In addition, an end plate 114 may extend further from the first axis 100 than the first center portion 110. The end plates 114 may help contain filaments 32 so that filaments 32 do not roll off an end of the first roller 50 and may help direct filaments 32 into a gap 116 that is located between the first roller 50 and the second roller 52. The size and configuration of the gap 116 may vary as the first roller 50 and the second roller 52 rotate.

Referring to FIGS. 1 and 2, the second roller 52 may be generally aligned with the first roller 50. As such, the second roller 52 may be positioned between the die plate 60 and the funnel 64 and may be positioned below and may be spaced apart from the die plate 60. At least a portion of the second roller 52 may be disposed above the funnel 64. As such, the second roller 52 may be at least partially received in the chamber 80. The second roller 52 be rotatable about a second axis 100′. In at least one configuration and as is best shown in FIG. 2, the second roller 52 may have a second center portion 110′, at least one recess 112′, one or more end plates 114′, or combinations thereof.

The second center portion 110′ may extend around or encircle the second axis 100′. In at least one configuration, the second center portion 110′ may be disposed at a constant or substantially constant radial distance from the second axis 100′. The second center portion 110′ may be positioned above the funnel 64.

At least one recess 112′ may extend from the second center portion 110′ toward the second axis 100′. In the configuration shown, a single recess 112′ is illustrated; however, it is contemplated that multiple recesses may be provided and that the recesses may be spaced apart from each other. In at least one configuration, a recess 112′ that is provided with the second roller 52 may not have mirror symmetry with a corresponding recess that is provided with the first roller 50, thereby allowing a mesh cushion to be formed with opposing sides that have different configurations.

One or more end plates 114′ may be provided with the second roller 52. In the configuration shown, two end plates 114′ are shown that are disposed proximate opposite ends of the second center portion 110′. An end plate 114′ may be rotatable about the second axis 100′ with the second center portion 110′. In addition, an end plate 114′ may extend further from the second axis 100′ than the second center portion 110′. The end plates 114′ may help contain filaments 32 so that filaments 32 do not roll off an end of the second roller 52 and may help direct filaments 32 into the gap 116.

An end plate 114 that is provided with the first roller 50 may engage and may overlap an adjacent end plate 114′ that is provided with the second roller 52 to help direct filaments 32 into the gap 116. In addition, an end plate may overlap a roller to which the end plate is not attached. For instance, an end plate 114 that is provided with the first roller 50 may overlap the second roller 52 to help direct filaments into the gap 116. In addition, or alternatively, an end plate 114 that is provided with the first roller 50 may have an outside circumference or outer surface that faces away from the first axis 100 that is disposed closer to the second axis 100′ than the second center portion 110′ is disposed to the second axis 100′. An end plate 114′ that is provided with the second roller 52 may have an outside circumference or outer surface that faces away from the second axis 100′ that is disposed closer to the first axis 100 than the first center portion 110 is disposed to the first axis 100. An end plate 114, 114′ may be received inside the funnel 64 or may be disposed outside the funnel 64. The outside circumference or outer surface of an end plate 114, 114′ may or may not be positioned above the funnel 64.

The roller drive unit 54 may be configured to rotate the first roller 50 and the second roller 52. For instance, the roller drive unit 54 may rotate the first roller 50 and the second roller 52 in opposite directions about their respective axes. In FIG. 1, the first roller 50 may be rotated in a clockwise direction about the first axis 100 from the perspective shown while the second roller 52 may be rotated in a counterclockwise direction about the second axis 100′ from the perspective shown as is represented by the curved arrow lines. In addition, the roller drive unit 54 may synchronize rotation of the first roller 50 and the second roller 52 so that the recess 112 of the first roller 50 is aligned with the recess 112′ of the second roller 52 during each roller revolution, thereby allowing opposite sides of the mesh cushion 12 to be formed with a desired cross section at each point along its length. Improper roller synchronization may result in recess misalignment and an improperly formed mesh cushion 12.

The roller drive unit 54 may include one or more motors, such as electric motors, servo motors, hydraulic motors, pneumatic motors, or the like. The roller drive unit 54 may also include a transmission assembly, such as a geared transmission assembly to reduce the rotation imparted by the motor(s) and provide a high torque output for rotating the rollers 50, 52. Of course, any rotary input and transmission may be provided by the roller drive unit 54.

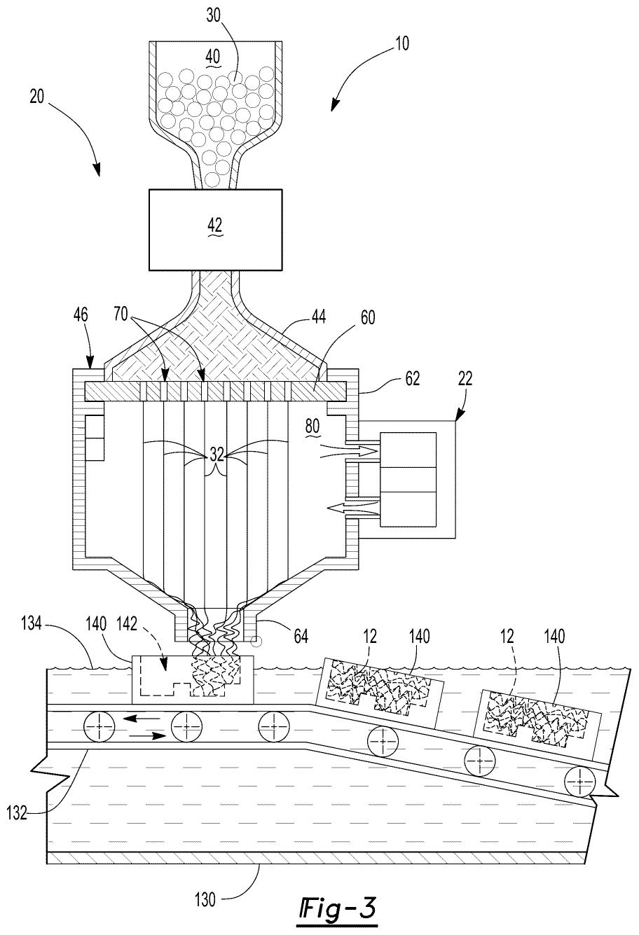

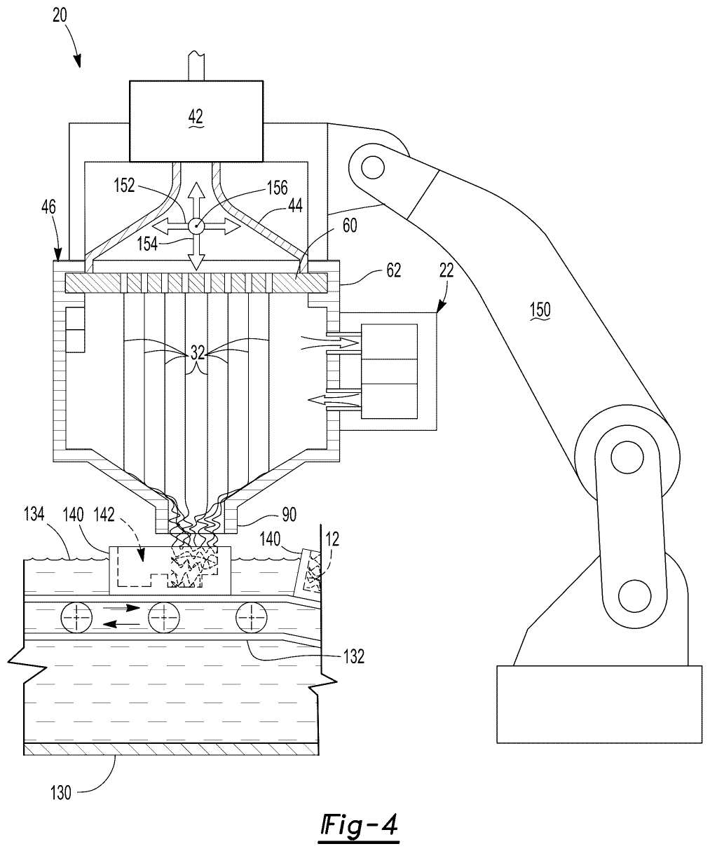

It is noted that the first roller 50, the second roller 52, and the roller drive unit 54 may be omitted in various extruder subassembly configurations, such as the configurations shown in FIGS. 3 and 4.

Filaments 32 may be deposited on the first roller 50 and the second roller 52 while the first roller 50 and the second roller 52 are rotating. Rotation of the first roller 50 and the second roller 52 may direct the filaments 32 toward and through the gap 116, thereby consolidating the filaments 32 and placing each filament 32 into contact with one or more other filaments 32. Filaments 32 may bend or twist in irregular ways and in a generally nonpatterned or nonrepeating manner. The recesses 112, 112′ may further form filaments 32 so that the filaments 32 that contact the surface of each roller that defines a corresponding recess 112, 112′ become a contoured exterior surface of the part. Thus, since the cross-sectional area of each roller varies due to the presence and configuration of a corresponding recess 112, 112′, the first and second rollers 50, 52 may form filaments 32 into a mesh cushion 12 having a variable cross-sectional shape.

Referring to FIG. 1, the environmental control subsystem 22 may control one or more attributes or characteristics of the air inside the chamber 80. For instance, the environmental control subsystem 22 may control the temperature of air in the chamber 80, the humidity of air in the chamber 80, the flow of air in the chamber 80, recirculation of air in the chamber 80, exhausting air from the chamber 80, or combinations thereof, to help control the thickness of the filaments 32. In at least one configuration, the environmental control subsystem 22 may include a fan 120 and one or more temperature modifying devices.

In FIGS. 1, 3, and 4, two temperature modifying devices 122, 124 are shown; however, it is contemplated that a different number of temperature-modifying devices may be provided. A temperature modifying device may have any suitable configuration. For instance, a temperature modifying device may be configured as a heat exchanger, heating element, cooling element, thermocouple, electrical resistance heater, fuel heater, friction heater, or the like. As one example, a first temperature modifying device 122 may be configured to heat air while a second temperature modifying device 124 may be configured to cool and/or dehumidify air that is circulated by the fan 120 from the chamber 80, through the environmental control subsystem 22, and back to the chamber 80 by utilization of a coolant, refrigeration cycle, heat exchanger, radiator, compressor, thermoelectric device, or the like.

The environmental control subsystem 22 may be used to maintain the temperature of the air in the chamber 80 within a predetermined temperature range. The predetermined temperature range may be slightly less than the melting temperature of the material 30. As an example, the predetermined temperature range may be no more than 10° F. less than the melting temperature of the material 30. Similarly, the environmental control subsystem 22 may be used to maintain the humidity of the air in the chamber 80 within a predetermined humidity range, by utilizing a dehumidifier, a condenser, or the like.

Components of the environmental control subsystem 22, such as the fan 120, and the temperature modifying devices 122, 124 may be mounted to the housing 62 or may be remotely positioned from the extruder subsystem 20 and fluidly connected to the chamber 80 by any suitable conduit, such as a hose or duct.

The material handling subsystem 24 may receive the material 30 after the material 30 exits the extruder subsystem 20. The material handling subsystem 24 may be provided in various configurations. In the configuration shown in FIG. 1, the material handling subsystem 24 includes a tank 130 and a conveyor 132. The conveyor 132 may be a belt conveyor, a chain conveyor, a pallet conveyor, or the like. The conveyor 132 may include rollers driven by at least one motor and at least one transmission.

The tank 130 may receive the material 30 exiting the extruder subsystem 20. In addition, the tank 130 may receive a fluid 134, such as water, coolant, glycol, a combination thereof, any inert liquid, or the like. The fluid 134 may be provided in a liquid state and may be provided at a temperature that is significantly less than the melting temperature of the material 30. As such, the fluid 134 may cool and harden the filaments 32 into the mesh cushion 12. Thus, the fluid 134 may cool the filaments 32 so that the filaments 32 are no longer in a sticky molten state.

The conveyor 132 may transport the mesh cushion 12. In the least one configuration, the conveyor 132 or a portion thereof may be received in the tank 130 and may be at least partially submerged in the fluid 134. The length of the conveyor 132 that is disposed in the fluid 132 may be sufficient to provide adequate cooling and hardening of the filaments 32 for subsequent material handling operations.

In the configuration shown in FIG. 1, a portion of the conveyor 132 is shown that is located below the extruder subsystem 20 and that is submerged in the fluid 134. The conveyor 132 may be spaced apart from the extruder subsystem 20 and the funnel 64 so that there is sufficient space for the filaments 32 to exit the funnel 64. The conveyor 132 may be disposed closer to the surface of the fluid 134 than is shown. Moreover, it is contemplated that a portion of the conveyor 132 may exit the fluid 134 to facilitate removal of the mesh cushion 12 from the tank 130.

In the configuration shown in FIG. 3, the material handling subsystem 24 may also include at least one mold 140. The mold 140 may be positionable on the belt of the conveyor 132 and the conveyor 132 may be configured to move the mold 140 with respect to the extruder subsystem 20. The mold 140 may define a mold cavity 142 into which the filaments 32 may be deposited or dispensed. The mold cavity 142 may be open in a direction that faces upward or toward the extruder subsystem 20.

The mold 140 may or may not be positioned in the tank 130 when filaments 32 are deposited into the mold cavity 142. In FIGS. 3 and 4, an example is shown in which the mold 140 is partially received in the fluid 134 when the filaments 32 are deposited into the mold cavity 142. In a configuration in which the extruder subsystem 20 is stationary, the conveyor 132 may advance the mold 140 underneath the funnel 64 and with respect to the funnel 64, thereby allowing the mold cavity 142 to be filled with filaments 32. The mold 140 may then be lowered into the fluid 134.

The mold 140 may be lowered into or at least partially submerged into the fluid 134 in various ways. In the configuration shown, the conveyor 132 is configured to lower the mold 140 into the fluid 134. The conveyor 132 is inclined downward into the tank 130 so that the mold 140 is lowered into the fluid 134 as the mold 140 moves away from the funnel 64, thereby allowing the fluid 134 to circulate through the filaments 32 and the mold cavity 142 to cool and harden the filaments 32. As another example, the mold 140 may be lowered into the fluid 134 or lifted out of the fluid 134 without the use of a conveyor 132, such as by moving the mold 140 in a generally vertical direction or in a rotating loop that may move into and out of the fluid 134. It is also contemplated that the conveyor 132 may be omitted and that the mold 140 may be moved manually or in another manner, such as during small batch manufacturing.

In the configuration shown in FIG. 4, material handling subsystem 24 may be similar to or the same as that shown in FIG. 3. However, in FIG. 4 the extruder subsystem 20 is mounted to or coupled to a robotic manipulator 150. The robotic manipulator 150 may be an industrial robot, as is known in the art. For example, the robotic manipulator 150 may include a base that is stationary or mounted for translation upon a track. The robotic manipulator 150 may include an arm supported upon the base. The arm includes multiple links and linkages, for three to seven axes (or more) of translation or rotation. The axes of movement permit adjustment of the arm to various flexible positions. The robotic manipulator 150 may include a plurality of rotary actuators, such as electric servo motors, and transmissions connected to the links and linkages for driving each link and linkage. A controller may be in communication with the actuators to control the actuators to manipulate the arm, and consequently the extruder subsystem 20, to articulate to various programmed positions.

The robotic manipulator 150 may be movable along multiple axes and may have multiple degrees of freedom. For instance, the robotic manipulator 150 may be configured to move the extruder subsystem 20 along a first axis 152, a second axis 154, and a third axis 156. The first axis 152 may be a horizontal axis.

The second axis 154 may be a vertical axis that may be disposed perpendicular to the first axis 152 and that may extend in a left/right direction from the perspective shown.

The third axis 156 may be disposed perpendicular to the first axis 152 and the second axis 154 and may extend in a forward/backward direction from the perspective shown.

The extruder subsystem 20 may deposit filaments 32 into the mold cavity 142 when the mold 140 is stationary or in motion. It is also contemplated that the conveyor 132 may be omitted and that the mold 140 may be moved manually or in another manner, such as during small batch manufacturing. The configuration shown in FIG. 4 and its associated attributes will be discussed in more detail below.

Referring to FIG. 1, the control subsystem 26 may monitor and control operation of the system 10. For instance, the control subsystem 26 may include one or more or control modules or electronic controllers 200 that may monitor and/or control operation of one or more subsystems of the system 10. For instance, a controller 200 may be a microprocessor-based controller that may be electrically connected to or communicate with components of the extruder subsystem 20 such as the feeder 42 and the roller drive unit 54, the environmental control subsystem 22, the material handling subsystem 24, or combinations thereof. The controller 200 may also control operation of the robotic manipulator 150, if provided. For simplicity, a single controller is shown in FIG. 1; however, it is contemplated that multiple control modules or controllers, or a distributed control architecture may be provided with the control subsystem 26. The control subsystem 26 is also provided with the configurations shown in FIGS. 3 and 4 but has been omitted from these figures merely for clarity.

The controller 200 may also process input signals or data from various input devices or sensors. Input devices that may be provided with the system 10 may include a temperature sensor 160 and a humidity sensor 162.

The temperature sensor 160 may provide a signal indicative of the temperature of air in the chamber 80. The temperature sensor 160 may be of any suitable type, such as a thermistor, thermocouple, semiconductor-based temperature sensor, infrared sensor, or the like. The temperature sensor 160 may be provided in any suitable location. For instance, the temperature sensor 160 may be provided in the chamber 80 or may be provided in the environmental control subsystem 22.

The humidity sensor 162 may provide a signal indicative of the humidity of air in the chamber 80. The humidity sensor 162 may be of any suitable type, such as a capacitive humidity sensor, resistive humidity sensor, or thermal conductivity humidity sensor. The humidity sensor 162 may be provided in any suitable location. For instance, the humidity sensor 162 may be provided in the chamber 84 or may be provided in the environmental control subsystem 22.

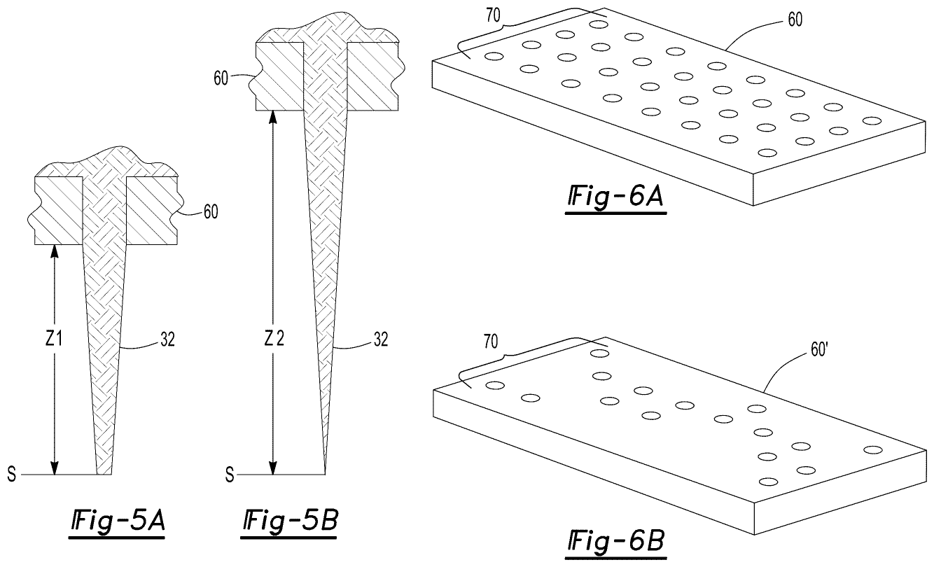

Referring again to FIG. 4, the robotic manipulator 150 may be configured to move the extruder subsystem 20 to vary the filament density of the mesh cushion 12. For example, the material 30 may be extruded through the filament forming openings 70 in one or more die plates 60 at a substantially constant flow rate. Thus, the filaments 32 may be expected to have substantially the same diameter or thickness given a constant filament forming opening size. However, the filaments 32 become thinner as the distance from the die plate 60 and the filament forming openings 70 increases. This is best understood with reference to FIGS. 5A and 5B.

In FIG. 5A, a magnified view of a portion of a die plate 60 and a filament forming opening 70 is shown. The die plate 60 is positioned at a first distance Z1 above a surface S.

In FIG. 5B, the die plate 60 is positioned at a second distance Z2 above the surface S, with Z1 being less than Z2. The filament 32 is thinner or has a smaller diameter at the surface S in FIG. 5B due to the thinning that occurs when the filament 32 extends over an increased distance and the material 30 is in a molten, non-hardened state. These characteristics may be used to vary the filament density of the mesh cushion 12. For instance, the robotic manipulator 150 may move the die plate 60 upward or away from the mold 140 to decrease the size, thickness, or diameter of the filaments 32 when deposited in the mold 140. Conversely, the robotic manipulator 150 may move the die plate 60 toward the mold 140 to increase the size, thickness, or diameter of the filaments 32 when deposited in the mold 140.

The robotic manipulator 150 may also move the die plate 60 when depositing filaments 32 to vary the filament density in other ways. For instance, the robotic manipulator 150 may repeatedly move the die plate 60 toward the mold 140 and then away from the mold 140 and/or decrease its rate of travel and/or increase its stationary dwell time to increase the filament density. As another example, the robotic manipulator 150 may move the die plate 60 in a horizontal plane (i.e., along the second axis 154 and/or the third axis 156) at a faster speed or spend less time in a particular area to decrease the filament density. Conversely, the robotic manipulator 150 may move the die plate 60 in the horizontal plane at a slower speed or spend more time in a particular area to increase the filament density. Accordingly, filament density may increase as the time spent at a particular area increases, which allows more filaments to be deposited, and filament density may decrease as the time spent in a particular area decreases.

It is also noted that in FIG. 4, the environmental control subsystem 22 and various components of the extruder subsystem 20 may be omitted, such as the portion of the housing 62 located below the die plate 60, the funnel 64, or both.

Referring to FIGS. 6A through 8B, examples of extruder subsystem configurations having interchangeable die plates or multiple die plates will now be discussed. Multiple die plates may be provided with any of the extruder subsystem configurations previously discussed, such as the configurations shown in FIGS. 1, 3, and 4.

FIGS. 6A and 6B show examples of two different die plates. The die plates 60, 60′ have the same size and shape but do not have the same number of filament forming openings 70. The die plate 60 in FIG. 6A has a greater number of filament forming openings 70 than the die plate 60′ in FIG. 6B. Thus, the number of filaments 32 that may be provided with the die plate 60 in FIG. 6A is greater than the number of filaments 32 that may be provided with the die plate 60′ in FIG. 6B. Accordingly, a mesh cushion 12 may be provided with a lower filament density using the die plate 60′ in FIG. 6B as compared to the die plate 60 in FIG. 6A given a constant material flow rate and dispensing time.

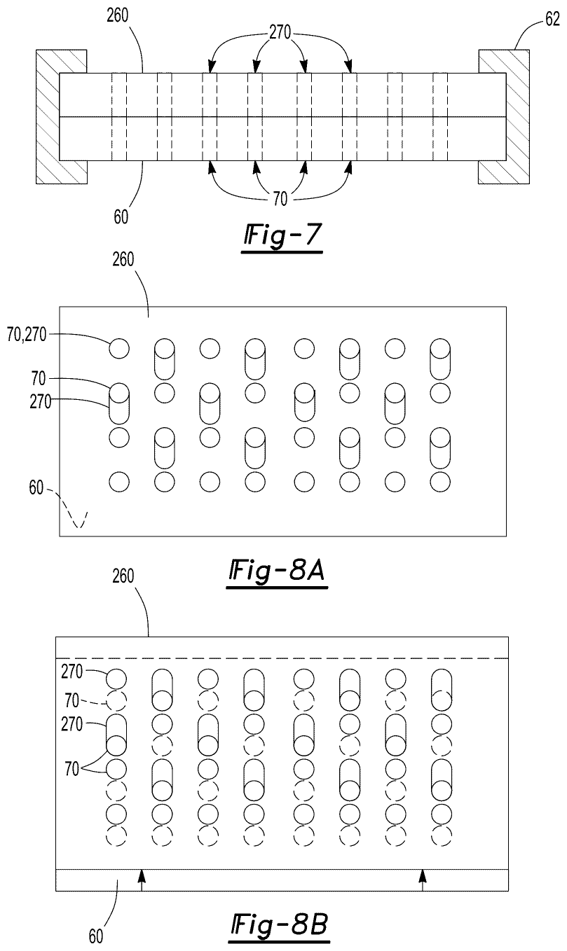

Referring to FIG. 7, a configuration having two stacked die plates is shown. At the outset, it is noted that it is contemplated that more than two die plates may be provided in a stacked arrangement.

The configuration in FIG. 7 will primarily be discussed in the context of a first die plate and a second die plate that are stacked directly on top of each other. For clarity, the lower die plate will be referred to as the first die plate while the die plate that rests on top of the first die plate will be referred to as the second die plate; however, it is contemplated that the positioning of the first die plate and the second die plate may be changed or reversed and that additional die plates may be provided.

As an example, the first die plate 60 may be configured as shown in FIG. 6A. The first die plate 60 may have a first set of filament forming openings 70. In at least one configuration, members of the first set of filament forming openings 70 may be provided with the same configuration.

Referring to FIGS. 7 and 8A, an example of a second die plate 260 is shown. The second die plate 260 may be disposed adjacent to the first die plate 60 and may have a second set of filament forming openings 270. Members of the second set of filament forming openings 270 may or may not have the same configuration. For example, in FIG. 8A the members of the second set of filament forming openings 270 do not all have the same configuration. Instead, some filament forming openings 270 have the same configuration as the filament forming openings 70 of the first die plate 60 (represented as circles in FIG. 8A) and some filament forming openings 270 are larger than the filament forming openings 70 in the first die plate 60 (represented as elongated oval slots and FIG. 8A). It is also contemplated that the second set of filament forming openings 270 may have fewer members than the first set of filament forming openings 70.

The relative positioning of the second die plate 260 with respect to the first die plate 60 may be adjustable to change the alignment of the filament forming openings 70, 270 with respect to each other. Alignment changes may be accomplished by moving the first die plate 60 or a portion thereof with respect to the second die plate 260, by moving the second die plate 260 or a portion thereof with respect to the first die plate 60, or both. As an example, the first die plate 60 may be held in a stationary position and the second die plate 260 may be slid or moved along the first die plate 60 such the second die plate 260 blocks at least some of the filament forming openings 70 and the first die plate 60. This is best understood by comparing FIGS. 8A and 8B.

In FIG. 8A, the second die plate 260 is shown in an example of a first position. In this example, the second die plate 260 does not block any of the filament forming opening 70 in the first die plate 60 when in the first position. As such, the material 30 may be extruded through the second set of filament forming openings 270 and then through a corresponding member of the first set of filament forming openings 70 that is aligned with a member of the second set of filament forming openings 270 to form a filament 32.

In FIG. 8B, the relative positioning of the first and second die plates 60, 260 is changed as compared to FIG. 8A. In the example in FIG. 8B, the first die plate 60 remains in the same position as in FIG. 8A and the second die plate 260 has been moved to a second position that differs from the first position. As a result, some of the members of the second set of filament forming openings 270 remain aligned with corresponding members of the first set of filament forming openings 70 while other members of the second set of filament forming openings 270 are no longer aligned with members of the first set of filament forming openings 70. As such, the second die plate 260 is positioned to prevent material from reaching and passing through a member of the first set of filament forming openings 70.

More specifically in the example shown, members of the second set of filament forming openings 270 having a circular shape are no longer aligned with any member of the first set of filament forming openings 70 while the elongated oval-shaped members of the second set of filament forming openings 270 have been repositioned but are still sufficiently aligned with a corresponding member of the first set of filament forming openings 70 to permit material 30 to be extruded through the aligned filament forming openings 70. Thus, the larger members (i.e., oval shaped members) of the second set of filament forming openings 270 may permit material 30 to flow through a corresponding member of the first set of filament forming openings 70 when the second die plate 260 is in the first position and in the second position. As a result, filaments 32 are extruded when the second die plate 260 is in the first position and in the second position but the number of filaments 32 that are formed by the die set is reduced when the second die plate 260 is in the second position.

It is contemplated that a die plate may move in a different manner than previously described. As one example, a die plate may be split into multiple pieces that may be independently movable. For instance, the second die plate 260 may be split in half and each half of the second die plate 260 may be movable to selectively block or permit the flow of material 30 through a subset of the first set of filament forming openings 70.

As another example, a die plate may be rotatable about an axis rather than movable in a linear direction.

As another example, multiple die plate regions may be integrated into a single plate that may be rotatable about an axis. Each die plate region may have a different pattern of filament forming openings. The single plate may then be rotated about the axis to align a specific die plate region with another die plate. As a result, each die plate region may provide a different number of filaments when positioned adjacent to or aligned with the other die plate.

It is also contemplated that the second die plate 260 may be movable to a position in which the second die plate 260 blocks all of the members of the first set of filament forming openings 70 of the first die plate 60, thereby terminating the flow of material through the die plates and terminating the extrusion of filaments 32.

In a first aspect, a method of making a mesh cushion is provided. The method may include extruding a material through a plurality of filament forming openings in a die plate to form a plurality of filaments. The filaments may be deposited on a first roller and a second roller. The first roller may be rotatable about a first axis and may define a first recess. The second roller may be rotatable about a second axis and may define a second recess. The first roller and the second roller may be rotated to direct the filaments into the first recess and the second recess and through a gap that is located between the first roller and the second roller, thereby forming the filaments into a mesh cushion having a variable cross-sectional shape.

In a second aspect, the method of the first aspect may be provided, wherein the first and second rollers may be spaced apart from the die plate and may be positioned below the die plate.

In a third aspect, the method of the first aspect or the second aspect may be provided, wherein the filaments may be deposited while the first roller and the second roller are rotating.

In a fourth aspect, the method of any of the first aspect to the third aspect may be provided, wherein the first recess and the second recess may not have mirror symmetry.

In a fifth aspect, the method of any of the first aspect to the fourth aspect may be provided, wherein the first roller may include a first center portion and a first end plate. The first recess may extend from the first center portion. The first end plate may be rotatable about the first axis with the first center portion. The first end plate may extend further from the first axis than the first center portion. The first end plate may overlap the second roller to direct filaments into the gap between the first and second rollers.

In a sixth aspect, the method of the fifth aspect may be provided, wherein the second roller may include a second center portion and a second end plate. The second recess may extend from the second center portion. The second end plate may be rotatable about the second axis with the second center portion. The second end plate may extend further from the second axis than the second center portion. The second end plate may overlap the first roller to direct filaments into the gap between the first and second rollers.

In a seventh aspect, the method of the sixth aspect may be provided, wherein the first end plate of the first roller and the second end plate of the second roller may overlap each other to direct filaments into the gap.

In an eighth aspect, the method of any of the first aspect to the seventh aspect may be provided, wherein at least a portion of the first roller and at least a portion of the second roller may be positioned above a funnel that defines a funnel opening through which the material may pass.

In a ninth aspect, the method of the eighth aspect may be provided, wherein the filaments that are extruded through the die plate may be provided to a chamber that is partially defined by a housing that extends between the die plate and the funnel. The first roller and the second roller may be at least partially received in the chamber.

In a tenth aspect, the method of the ninth aspect may be provided, wherein the first roller and the second roller are at least partially received in the chamber.

In an eleventh aspect, the method of the ninth aspect or the tenth aspect may be provided, wherein an environmental control subsystem controls temperature and humidity of air in the chamber to control thickness of the filaments.

In a twelfth aspect, the method of the eleventh aspect may be provided, wherein the environmental control subsystem may be mounted to the housing. The environmental control subsystem may maintain the temperature of air in the chamber within a predetermined temperature range. The predetermined temperature range may be no more than 10° F. less than the melting temperature of the material.

In a thirteenth aspect, a mesh cushion is made by the method of any of the first aspect to the twelfth aspect.

In a fourteenth aspect, a system to make the mesh cushion according to any of the first aspect to the twelfth aspect is provided with an extruder to extrude the material, the die plate, the first roller, and the second roller.

In a fifteenth aspect, a method of making a mesh cushion may include extruding material through a plurality of filament forming openings in a die plate to form a plurality of filaments. The filaments may be directed into a funnel to consolidate and engage the filaments. The filaments may then be deposited into a mold. The mold may be at least partially submerged into a fluid to cool and harden the filaments into a mesh cushion.

In a sixteenth aspect, the method of the fifteenth aspect may be provided, wherein the mold may be disposed on a conveyor. The conveyor may move or lower the mold into the fluid.

In a seventeenth aspect, the method of the fifteenth aspect or the sixteenth aspect is provided, wherein the mold may be partially received in the fluid when the filaments are deposited.

In an eighteenth aspect, the method of any of the fifteenth aspect to the seventeenth aspect may be provided, wherein the filaments that are extruded through the die plate may be provided to a chamber that includes the housing and that extends between the die plate and the funnel.

In a nineteenth aspect, a mesh cushion is made by the method of any of the fifteenth aspect to the eighteenth aspect.

In a twentieth aspect, a system to make the mesh cushion according to the method of any of the fifteenth aspect to the eighteenth aspect, provides an extruder to extrude the material, the die plate, the funnel, and the mold.

In a twenty-first aspect, a method of making a mesh cushion may include providing a die set that includes a first die plate and a second die plate that are disposed adjacent to each other. The material may be extruded through a first set of filament forming openings in the first die plate and through a second set of filament forming openings in the second die plate to form a plurality of filaments. The relative position of the second die plate with respect to the first die plate may be changed so that the second die plate prevents the material from passing through some members of the first set of filament forming openings, thereby reducing the number of filaments that are formed by the die set. Filaments formed by the die set may be submerged into a fluid to cool and harden the filaments into the mesh cushion.

In a twenty-second aspect, the method of the twenty-first aspect may be provided, wherein the second set of filament forming openings may have fewer members than the first set of filament forming openings.

In a twenty-third aspect, the method of the twenty-first aspect or the twenty-second aspect may be provided, wherein the second die plate may be movable between a first position and a second position. The second die plate may permit the material to pass through some of the members of the first set of filament forming openings when the die plate is in the first position and in the second position.

In a twenty-fourth aspect, the method of any of the twenty-first aspect to the twenty-third aspect may be provided, wherein at least one member of the second set of filament forming openings may be larger than a member of the first set of filament forming openings to permit material to flow through the member of the first set of filament forming openings when the second die plate is in the first position and in the second position.

In a twenty-fifth aspect, the method of any of the twenty-first aspect to the twenty-fourth aspect may be provided, wherein filaments may be directed into a funnel to consolidate and engage the filaments before submerging the filaments.

In a twenty-sixth aspect, a method of making a mesh cushion may include extruding a material through a plurality of filament forming openings in a die plate to form a plurality of filaments. The die plate may be coupled to a robotic manipulator that is configured to move the die plate along a plurality of axes. The filaments may be deposited into a mold. The mold may be at least partially submerged into a fluid to cool and harden the filaments, thereby forming the filaments into the mesh cushion. The robotic manipulator may move the die plate when depositing the filaments to vary a filament density of the mesh cushion.

In a twenty-seventh aspect, the method of the twenty-sixth aspect may be provided, wherein material may be extruded through the plurality of filament forming openings at a substantially constant flow rate.

In a twenty-eight aspect, the method of the twenty-sixth aspect or the twenty-seventh aspect may be provided, wherein the robotic manipulator may move the die plate away from the mold to decrease the diameter of the filaments when the filaments reach and are deposited in the mold.

In a twenty-ninth aspect, the method of any of the twenty-sixth aspect to the twenty-eighth aspect may be provided, wherein the robotic manipulator may move the die plate toward the mold to increase the diameter of the filaments when the filaments reach and are deposited in the mold.

In a thirtieth aspect, the method of any of the twenty-sixth aspect to the twenty-ninth aspect may be provided, wherein the robotic manipulator may repeatedly move the die plate toward the mold and then away from the mold to change the filament density.

In a thirty-first aspect, the method of any of the twenty-sixth aspect to the thirtieth aspect may be provided, wherein the robotic manipulator may move the die plate in a horizontal plane at a faster speed to decrease filament density and at a slower speed to increase the filament density.

In a thirty-second aspect, a mesh cushion is made by the method of any of the twenty-sixth aspect to the thirty-first aspect.

In a thirty-third aspect, a system to make the mesh cushion according to the method of any of the twenty-sixth aspect to the thirty-first aspect, is provided with an extruder to extrude the material, the die plate, the robotic manipulator, and the mold.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of making a mesh cushion comprising:
extruding a material through a plurality of filament forming openings in a die plate to form a plurality of filaments;
depositing the filaments on a first roller and a second roller, wherein the first roller is rotatable about a first axis and defines a first recess, and the second roller is rotatable about a second axis and defines a second recess; and
rotating the first roller and the second roller to direct the filaments into the first recess and the second recess and through a gap between the first roller and the second roller, thereby forming the filaments into the mesh cushion having a variable cross-sectional shape.

2. The method of claim 1 wherein the first and second rollers are spaced apart from and positioned below the die plate.

3. The method of claim 1 wherein the filaments are deposited while the first roller and the second roller are rotating.

4. The method of claim 1 wherein the first recess and the second recess do not have mirror symmetry.

5. The method of claim 1 wherein the first roller includes a first center portion from which the first recess extends and a first end plate that is rotatable about the first axis with the first center portion and extends further from the first axis than the first center portion, wherein the first end plate overlaps the second roller to direct filaments into the gap between the first and second rollers.

6. The method of claim 5 wherein the second roller includes a second center portion from which the second recess extends and a second end plate that is rotatable about the second axis with the second center portion and extends further from the second axis than the second center portion, wherein the second end plate overlaps the first roller to direct filaments into the gap between the first and second rollers.

7. The method of claim 6 wherein the first end plate of the first roller and the second end plate of the second roller overlap each other to direct filaments into the gap between the first and second rollers.

8. The method of claim 1 wherein at least a portion of the first roller and the second roller are positioned above a funnel that defines a funnel opening through which the material passes.

9. The method of claim 8 wherein the filaments that are extruded through the die plate are provided to a chamber that is partially defined by a housing that extends between the die plate and the funnel.

10. The method of claim 9 wherein the first roller and the second roller are at least partially received in the chamber.

11. The method of claim 9 wherein an environmental control subsystem controls temperature and humidity of air in the chamber to control thickness of the filaments.

12. A method of making a mesh cushion comprising:
extruding a material through a plurality of filament forming openings in a die plate to form a plurality of filaments;
directing the filaments into a funnel to consolidate and engage the filaments;
depositing the filaments into a mold; and
at least partially submerging the mold into a fluid to cool and harden the filaments into the mesh cushion.

13. The method of claim 12 wherein the mold is disposed on a conveyor and the conveyor moves the mold into the fluid.

14. The method of claim 12 wherein the mold is partially received in the fluid when the filaments are deposited.

15. The method of claim 12 wherein the filaments that are extruded through the die plate are provided to a chamber that includes a housing that extends between the die plate and the funnel.

16. A method of making a mesh cushion comprising:
extruding a material through a plurality of filament forming openings in a die plate to form a plurality of filaments, wherein the die plate is coupled to a robotic manipulator that is configured to move the die plate along a plurality of axes;
depositing the filaments into a mold; and
at least partially submerging the mold into a fluid to cool and harden the filaments, thereby forming the filaments into the mesh cushion, wherein the robotic manipulator moves the die plate when depositing the filaments to vary a filament density of the mesh cushion.

17. The method of claim 16 wherein the material is extruded through the plurality of filament forming openings at a substantially constant flow rate.

18. The method of claim 16 wherein the robotic manipulator moves the die plate away from the mold to decrease a diameter of the filaments when deposited in the mold.

19. The method of claim 16 wherein the robotic manipulator moves the die plate toward the mold to increase a diameter of the filaments when deposited in the mold.

20. The method of claim 16 wherein the robotic manipulator moves the dic plate in a horizontal plane at a faster speed to decrease the filament density and at a slower speed to increase the filament density.
